(19) United States
(12) Patent Application Publication
(10) Pub. No.: US 2026/0237858 A1
(43) Pub. Date: Aug. 13, 2026

(54) CURRENT COLLECTOR ASSEMBLY WITH DIAGONAL BUSBARS

(71) Applicant: Rivian IP Holdings, LLC, Irvine, CA (US)

(72) Inventors: Jonathan VERGHESE, Costa Mesa, CA (US); Daniel Kurt MEHR, Irvine, CA (US); Sunoj Cherian GEORGE, Irvine, CA (US)

(21) Appl. No.: 19/052,082

(22) Filed: Feb. 12, 2025

(51) Int. Cl. H01M 50/503; B60L 50/64; H01M 10/42; H01M 10/48; H01M 50/209; H01M 50/284; H01M 50/507

(52) U.S. Cl. CPC H01M 50/503; B60L 50/64; H01M 10/425; H01M 10/482; H01M 50/209; H01M 50/284; H01M 50/507; H01M 2220/20

(57) ABSTRACT

A battery module includes multiple diagonal busbars that electrically connects battery cells (e.g., prismatic battery cells) electrically in series and/or in parallel. The diagonal shape of the busbars allow the busbars to electrically couple to additionally battery cells, thus increasing the energy output of the battery module. Additionally, at least some components of a battery module may generally remain in the same or similar location.

Batteries are often used as a source of power, including as a source of power for electric vehicles that include wheels that are driven by an electric motor that receives power from the batteries. A battery may include several battery cells carried within a module and/or a carrier.

Aspects of the subject technology can help to improve the versatility and interchangeability (e.g., electrical configurations) of battery modules within a battery subassembly for electric vehicles, which can help to mitigate climate change by reducing greenhouse gas emissions.

### SUMMARY

The subject technology is directed to battery packs, including battery subassemblies, current collector assemblies having diagonal busbars. The diagonal busbars may cross over battery cells (that form a battery module) and form electrical connections, both electrically in series and in parallel, that increases the overall energy output of battery packs. Moreover, the diagonal busbars may reduce complexities of engineering and re-design of battery packs, as several components may remain in the same or similar position as compared to other battery packs with different electrical configurations. For example, the module terminals may generally remain in the same or similar position based on the integration of diagonal busbars.

In one or more aspects of the present disclosure, an apparatus is described. The apparatus may include a current collector assembly. The current collector assembly may include a first busbar that includes a first portion configured to electrically coupled to a first set of prismatic battery cells. The first busbar may further include a second portion positioned laterally with respect to the first portion, the second portion configured to electrically coupled to a second set of prismatic battery cells. The first busbar may further include a third portion connected the first portion and the second portion. The third portion may be diagonal with respect to the first portion and the second portion.

The third portion may include a first opening aligned with a first vent of a prismatic battery cell of the first set of prismatic battery cells. The third portion may further include a second opening aligned with a second vent of a prismatic battery cell of the second set of prismatic battery cells.

The first busbar may be configured to electrically couple the first set of prismatic battery cells to the second set of prismatic battery cells. the first busbar may be configured to electrically couple in parallel the first set of prismatic battery cells to the second set of prismatic battery cells. The first busbar may be configured to electrically couple in parallel at least three prismatic battery cells of the first set of prismatic battery cells or the second set of prismatic battery cells. The first busbar may be configured to electrically couple in parallel at least six prismatic battery cells. The at least six prismatic battery cells may be from the first set of prismatic battery cells and from the second set of prismatic battery cells. The first busbar may be configured to electrically couple in parallel at least three positive terminals of the first set of prismatic battery cells to at least three positive terminals of the second set of prismatic battery cells.

The current collector assembly may further include a second busbar electrically coupled with the first set of prismatic battery cells. The first busbar may include a first shape. The second busbar may include a second shape different from the first shape.

In one or more aspects of the present disclosure, a battery subassembly is described. The battery subassembly may include a battery module. The battery module may include a first prismatic battery cell having a first type terminal. The battery module may further include a second prismatic battery cell separate from the first prismatic battery cell and having the first type terminal. The battery module may further include a busbar. The busbar may include a first portion electrically coupled to the first type terminal of the first prismatic battery cell. The busbar may further include a second portion electrically coupled to the first type terminal of the second prismatic battery cell. The busbar may further include a third portion connected to the first portion and the second portion.

The first type terminal may include a positive terminal. The first portion may be parallel with respect to the second portion. The third portion may be structurally non-parallel with respect to the first portion and the second portion.

The battery assembly may further include a circuit board disposed over the busbar. The battery assembly may further include a sensor electrically coupled to the circuit board and configured to monitor the first prismatic battery cell. The first portion may be configured to electrically couple with at least three prismatic battery cells. The second portion may be configured to electrically couple with at least three prismatic battery cells. The busbar may be configured to electrically couple in parallel six prismatic battery cells.

In one or more aspects of the present disclosure, a vehicle is described. The vehicle may include a battery subassembly. The battery subassembly may include a first busbar configured to electrically couple in parallel i) a first set of prismatic battery cells that includes at least three prismatic battery cells and ii) a second set of prismatic battery cells that includes at least three prismatic battery cells. The first busbar may include a first shape. The battery subassembly may further include a second busbar configured to electrically couple in series i) the first set of prismatic battery cells and ii) a third set of prismatic battery cells. The second busbar may include a second shape different from the first shape.

The first busbar may include a first portion configured to electrically couple to the first set of prismatic battery cells. The first busbar may further include a second portion configured to electrically couple to the second set of prismatic battery cells. The first busbar may further include a third portion connected to the first portion and the second portion. The first portion may be parallel with respect to the second portion. The third portion may be structurally non-parallel with respect to the first portion and the second portion.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack, in accordance with one or more implementations of the present disclosure.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery modules that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 2G illustrates a perspective view of an example in which a battery cell is implemented as a prismatic cell, in accordance with one or more implementations of the present disclosure.

FIG. 3 illustrates an exploded view of an example of a battery pack, in accordance with one or more implementations of the present disclosure.

FIG. 4 illustrates an aerial view of an example of a battery pack, showing additional features of a battery module, in accordance with one or more implementations of the present disclosure.

FIG. 5 illustrates an enlarged aerial view of an example of a battery module, in accordance with one or more implementations of the present disclosure.

FIG. 6 illustrates an aerial view of an example of a busbar electrically coupled with several battery cells, in accordance with one or more implementations of the present disclosure.

FIG. 7 illustrates an enlarged aerial view of an example of the battery module, showing an exemplary electrical current flow path, in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to a current collector assembly (CCA) that includes diagonal busbars that facilitates in forming, for example, a configuration of three battery cells in parallel (3P), resulting in more energy output as opposed to a configuration of two battery cells in parallel (2P). Diagonal busbars may facilitate electrical connections at desired locations (e.g., corners) of a battery module (e.g., via module terminals) to electrically connect to another adjacent battery module and/or to a busbar. Also, within the battery module, diagonal busbars may make electrical connections with battery cells by crossing over some battery cells but without having to cross over another busbar, thus avoiding complex electrical isolation of the busbars. The busbars, including diagonal busbars, may electrically couple prismatic battery cells in series or in parallel. Further, the diagonal busbars may include holes, or openings, that align with respective vents of the prismatic battery cells, thus preventing the occlusion of vents of the prismatic battery cells. This may limit or prevent relocating the prismatic battery cells. The diagonal busbar may allow the 3P CCA to maintain the same module terminal position as the 2P CCA, thereby allowing the battery pack high voltage (HV) architecture to be the same.

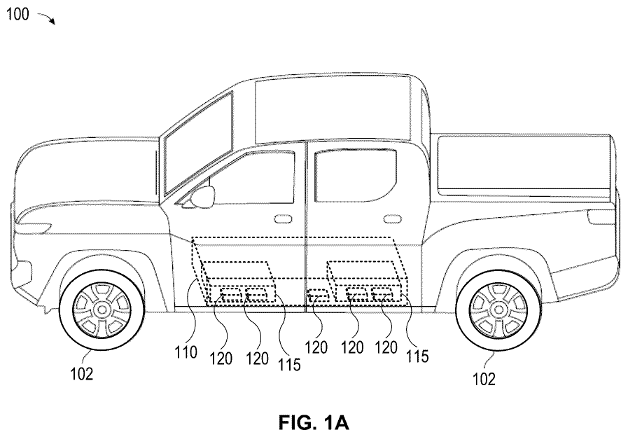

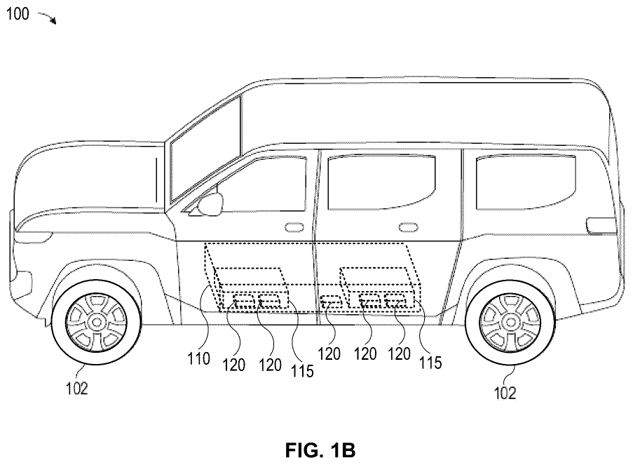

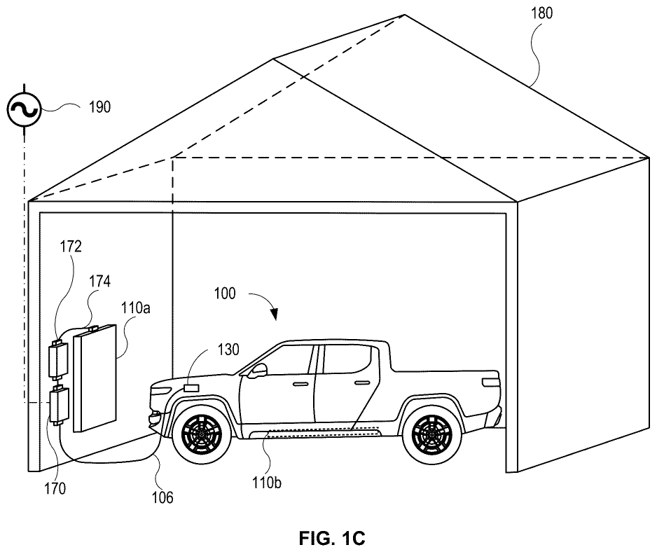

FIG. 1A illustrates an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle 100 using electric power from the battery pack 110. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

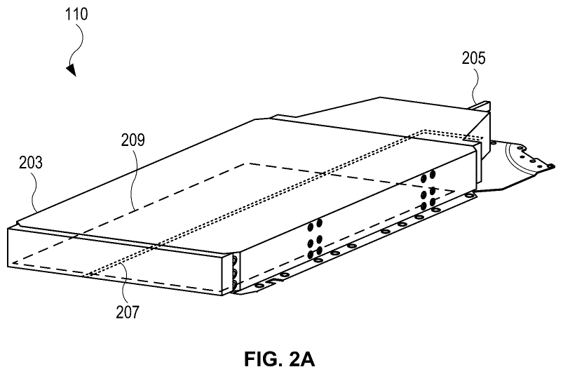

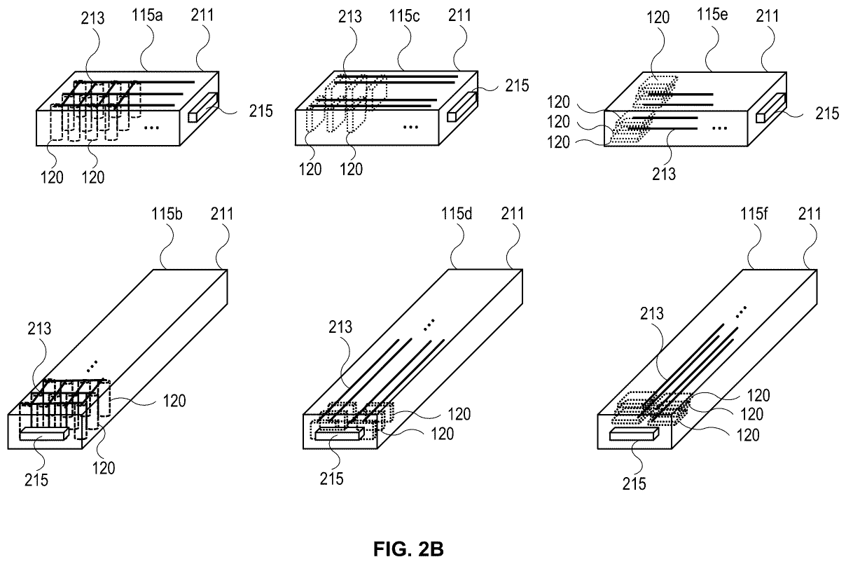

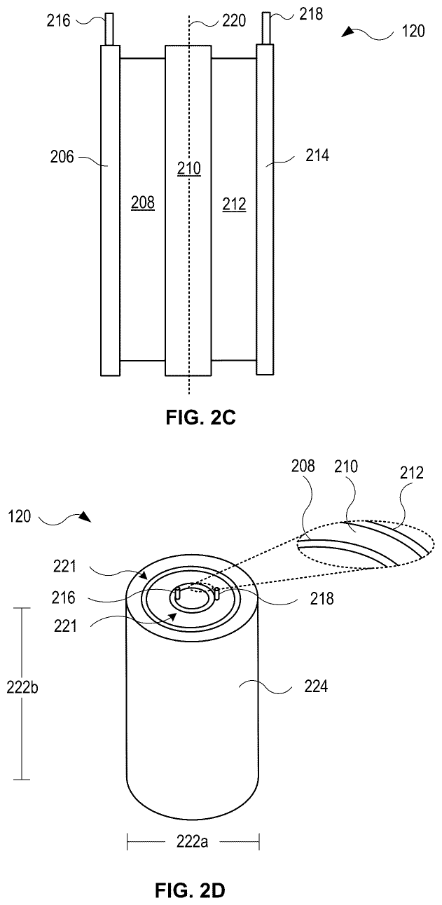

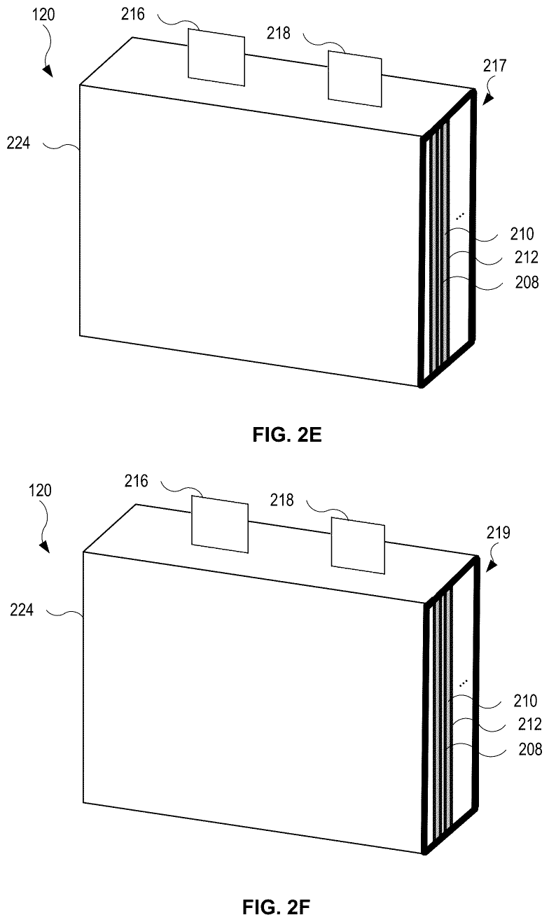

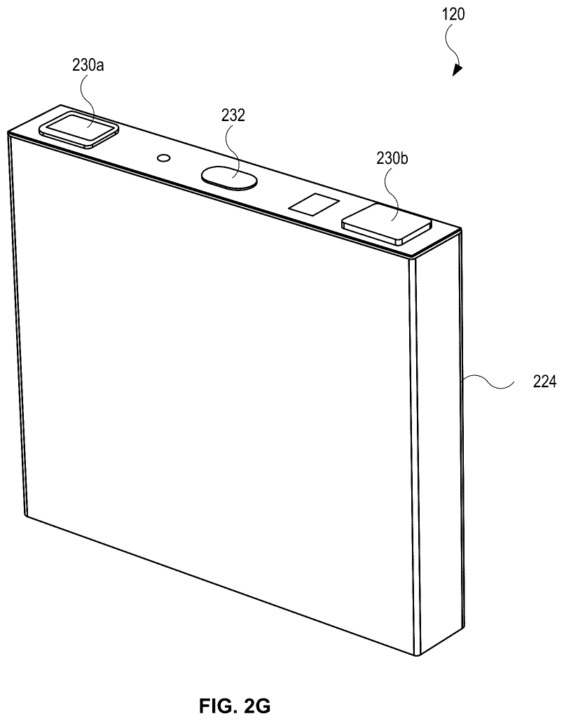

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

FIG. 2G illustrates a perspective view of an example in which the battery cell 120 is implemented as a prismatic cell, in accordance with one or more implementations of the present disclosure. The battery cell 120 may include any features shown and/or described herein for a prismatic battery cell. As shown, the battery cell 120 may include a cell housing 224, as well as a terminal 230a and a terminal 230b disposed on the cell housing 224. The terminal 230a and the terminal 230b may take the form of a positive battery terminal and a negative battery terminal, respectively. Also, the battery cell 120 may further include a vent 232. The vent 232 may be utilized to expel gas, such as gas within the cell housing 224.

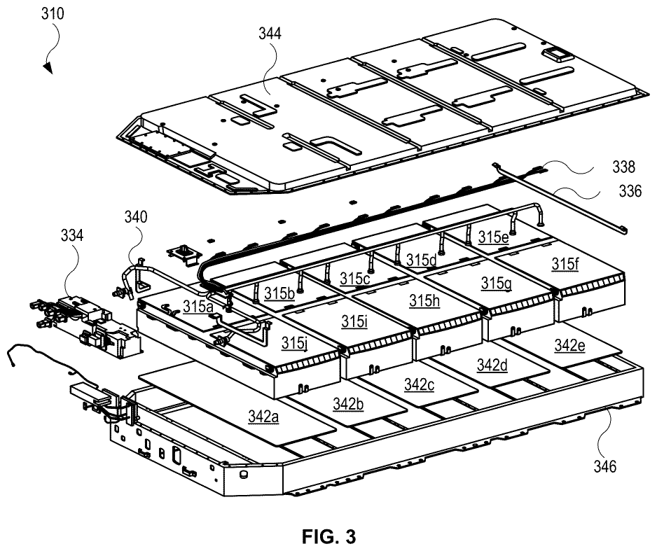

FIG. 3 illustrates an exploded view of an example of a battery pack 310, in accordance with one or more implementations of the present disclosure. The battery pack 310 may form a battery subassembly that is suitable for use in vehicles (e.g., electric vehicles shown in FIG. 1A and FIG. 1B). The battery pack 310 may include several battery modules. For example, the battery pack 310 may include a battery module 315a, a battery module 315b, a battery module 315c, a battery module 315d, a battery module 315e, a battery module 315f, a battery module 315g, a battery module 315h, a battery module 315i, and a battery module 315j. Each of the battery modules 315a-315j may be electrically coupled together using terminals and busbars shown and described below. In this regard, each of the battery modules 315a-315j may include several battery cells, which may include prismatic battery cells (e.g., similar to the battery cell 120 shown in FIG. 3). Based on the electrical coupling among the battery modules 315a-315j, the electrical current may flow from the battery module 315a to the battery module 315j. Each of the battery modules 315a-315j may include thirty six (36) battery cells. Accordingly, the battery pack 310 may include three hundred and sixty (360) battery cells. The number of battery cells should be construed as exemplary and non-limiting. Collectively, the battery modules 315a-315j may provide a voltage, or potential difference from a positive terminal to a negative terminal (not shown in FIG. 3), approximately in the range of 500 to 900 V. In one or more implementations, some of the battery modules may be grouped together to form two halves of a single battery module. For example, the battery modules 315a and 315j may be two halves of as single battery module.

The battery pack 310 may further include a high voltage distribution box 334 that electrically couples to the battery modules 315a-315j and distributes voltage from the battery modules 315a-315j to components, such as a drive unit(s) of a vehicle. Additionally, the battery pack 310 may include a busbar 336 that couples (e.g., electrically and mechanically) to the battery module 315e and the battery module 315f, thus providing an electrical current path from the battery modules 315a-315e to the battery modules 315f-315j. The battery pack 310 may further include a harness 338 utilized to monitor metrics, such as voltage and temperature, of the battery modules 315a-315j. Also, the battery pack 310 may further include a manifold 340 (e.g., cooling manifold) that is part of a cooling system for cooling the respective battery cells of the battery modules 315a-315j. The battery pack 310 may further include several pads. For example, the battery pack 310 may include a pad 342a, a pad 342b, a pad 342c, a pad 342d, and a pad 342e. Each of the pads 342a-342e may take the form of a foam pad that provide benefits such as structural damping and vibration.

In order to enclose the aforementioned components, the battery pack 310 may further include a cover 344 and an enclosure 346. The enclosure 346, or frame, may provide an internal volume, or cavity, to receive the aforementioned components. The cover 344 may couple with the enclosure 346 to enclose the aforementioned components.

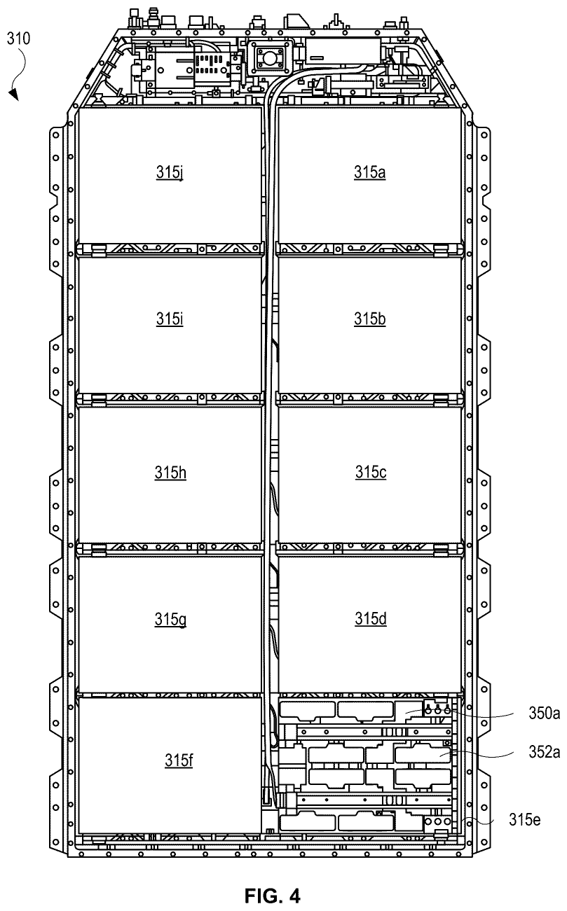

FIG. 4 illustrates an aerial view of the battery pack 310, showing additional features of the battery modules of the battery pack 310, in accordance with one or more implementations of the present disclosure. For purposes of illustration, features such as a cover and a CCA of the battery module 315e are removed. As shown, the battery module 315e includes several busbars. For example, the battery module 315e may include a busbar 350a and a busbar 352a, with the busbars 350a and 352a being representative of additional busbars of the battery module 315e. As shown, the busbar 350a may include a shape that is different from the shape of the busbar 352a. In this regard, the busbars 350a and 352a may electrically couple to a different number of battery cells.

The busbars 350a and 352a may place several battery cells, including some battery cells in other battery modules, in a particular electrical configuration. For example, the busbar 350a may electrically couple three (3) battery cells in parallel with each other. Moreover, the busbars 350a and 352a, in conjunction with additional busbars (some of which may be integrated with other battery modules), may electrically couple one hundred and twenty (120) battery cells in series with each other. The number of battery cells in series and parallel may vary. For example, the busbar 350a may electrically couple six (6) or more battery cells in parallel with each other, thus changing the energy output.

Additionally, some busbars may include a unique shape. For example, the busbar 350a may include a diagonal portion, or region, that allows the busbar 350a to electrically couple cross over several battery cells and electrically couple the battery cells together. This will be shown and described in further detail below. The battery module 315e may be representative of the remaining battery modules 315a-315e and 315f-315j.

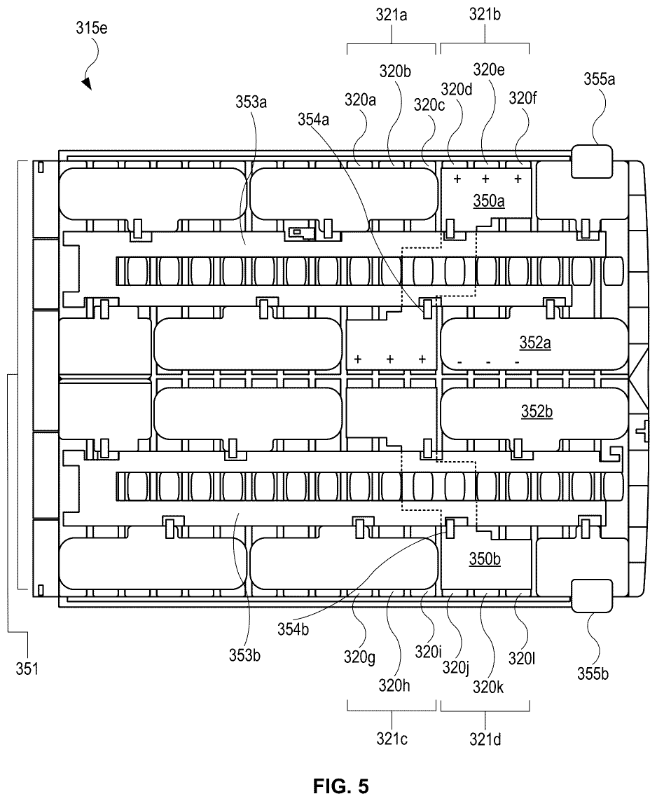

FIG. 5 illustrates an enlarged aerial view of the battery module 315e, in accordance with one or more implementations of the present disclosure. As shown, the battery module 315e may include several battery cells, such as a battery cell 320a, a battery cell 320b, a battery cell 320c, a battery cell 320d, a battery cell 320e, and a battery cell 320f. The battery module 315e may include several busbars that define a current collector assembly 351 that electrically couples together the battery cells of the battery module 315e. In this regard, the current collector assembly 351 may include a busbar 350a that electrically couples to the battery cells 320a-320c, and in particular, may electrically couple the battery cells 320a-320c in parallel. The battery cells 320a-320c may represent a set of battery cells 321a. As shown, respective terminals of a type (e.g., positive terminals denoted by a +(plus) sign) of the battery cells 320a-320c may be electrically coupled together in parallel. Based on the busbar 350a having a diagonal portion (discussed further below), the busbar 350a may further electrically couple to the battery cells 320d-320f, and in particular, may electrically couple the battery cells 320d-320f in parallel. The battery cells 320d-320f may represent a set of battery cells 321b. As shown, respective terminals of a type (e.g., positive terminals denoted by a +(plus) sign) of the battery cells 320d-320f may be electrically coupled together in parallel. In one or more implementations, the battery cells 320a-320f are electrically coupled together in parallel. Additionally, the busbar 352a (part of the current collector assembly 351) may electrically couple with the battery cells 320d-320f and electrically couple the battery cells 320d-320f with other battery cells (shown, not labeled) in series. As shown, respective terminals of a another type (e.g., negative terminals denoted by a (negative) sign) of the battery cells 320d-320f may be electrically coupled to the busbar 352a.

Similarly, the battery module 315e may include several battery cells, such as a battery cell 320g, a battery cell 320h, a battery cell 320i, a battery cell 320j, a battery cell 320k, and a battery cell 320l. The current collector assembly 351 may include a busbar 350b that electrically couples to the battery cells 320g-320i, and in particular, may electrically couple the battery cells 320g-320i in parallel. The battery cells 320g-320i may represent a set of battery cells 321c. Based on the busbar 350b having a diagonal portion (similar to the busbar 350a), the busbar 350b may further electrically couple to the battery cells 320j-315l, and in particular, may electrically couple the battery cells 320j-315lin parallel. The battery cells 320j-320l may represent a set of battery cells 321d. In one or more implementations, the battery cells 320g-320l are electrically coupled together in parallel. Additionally, the current collector assembly 351 may include a busbar 352b that electrically couples with the battery cells 320j-320l and electrically couple the battery cells 320j-320l with other battery cells (shown, not labeled) in series.

Further, at least some busbars may be overlap and at least partially covered by another busbar. For example, the battery module 315e may include a circuit 353a (e.g., circuit board, flexible circuit) that overlaps the busbar 350a. Additionally, the battery module 315e may include a circuit 353b (e.g., circuit board, flexible circuit) that overlaps the busbar 350b. The circuits 353a and 353b may electrically connect to one or more sensors that monitor the battery cells. For example, the circuit 353a is electrically coupled with a sensor 354a that takes the form of a temperature sensor that monitors the temperature of the battery cells 320a-320c (part of the set of battery cells 321a). Also, the circuit 353b is electrically coupled with a sensor 354b that takes the form of a temperature sensor that monitors the temperature of the battery cells 320g-320i (part of the set of battery cells 321c). As non-limiting examples, temperature sensors may include thermistors or thermocouples. The circuits 353a and 353b may also electrically connect to other sensors, such as voltage sensors.

The battery module 315e may a terminal 355a and a terminal 355b electrically coupled with the battery cells of the battery module 315e via the busbars. The terminals 355a and 355b (e.g., module terminals) may provide an electrical connection point with another battery module (e.g., battery module 315d shown in FIG. 4) and/or to another busbar (e.g., busbar 336 shown in FIG. 3).

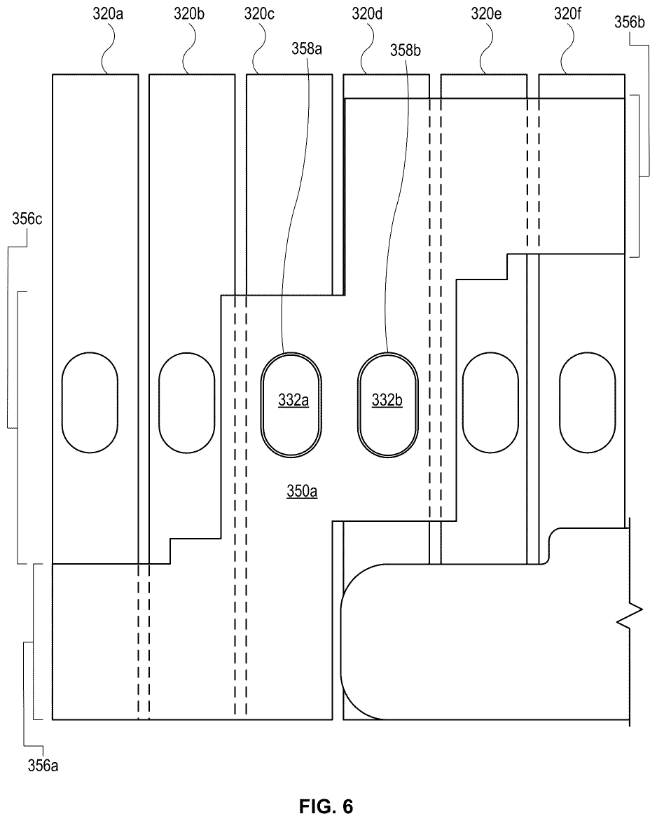

FIG. 6 illustrates an aerial view of an example of the busbar 350a electrically coupled with several battery cells, in accordance with one or more implementations of the present disclosure. As shown, the busbar 350a includes a portion 356a that is electrically coupled to the battery cell 320a, the battery cell 320b, and the battery cell 320c. The busbar 350a further includes a portion 356b that is electrically coupled to the battery cell 320d, the battery cell 320e, and the battery cell 320f. The portion 356a of the busbar 350a may be positioned laterally, or offset, with the respect to the portion 356b. Similarly, the portion 356b of the busbar 350a may be positioned laterally, or offset, with the respect to the portion 356a. The portion 356a may be structurally parallel with respect to the portion 356b, and vice versa. The busbar 350a may further include a portion 356c that is connected to, and positioned between, the portion 356a and the portion 356b. The phrase “positioned between” refers to a portion (e.g., structural portion) that lies in the middle, or approximately in the middle, of two adjoining portions. The portion 356c may allow the portions 356a and 356b to be positioned laterally with respect to each other to connect to (e.g., electrically couple with) respective battery cells, while also be connected to each other to form a single, unitary structure. In this regard, the portion 356c may be referred to as a diagonal portion, as the portion 356c is positioned diagonal, or diagonally, with respect to the portions 356a and 356b. The portion 356c may be characterized as being structurally non-parallel with respect to the portion 356a and the portion 356b. Also, based on the portion 356c, the busbar 350a may be referred to as a diagonal busbar.

While the busbar 350a may cover, or at least partially cover, the battery cells 320a-320f, the busbar 350a may include features to accommodate the battery cells 320a-320f. For example, the battery cell 320c and the battery cell 320d may include a vent 332a and a vent 332b, respectively. The busbar 350a may include an opening 358a and an opening 358b. As shown, the opening 358a and the opening 358b align with the vent 332a and the vent 332b, respectively. Beneficially, in the event either, or both, of the battery cell 320c and the battery cell 320d expel any gas, the busbar 350a may not impede the gas from exiting the battery cell 320c and the battery cell 320d via the vent 332a and the vent 332b, respectively, based on the opening 358a and the opening 358b, respectively. Beneficially, the openings 358a and 358b of the busbar 350a may limit or prevent requirements for relocating the battery cells 315a-135f. The busbar 350a may be representative of other busbars integrated with battery modules of a battery pack (e.g., battery pack 310 shown in FIG. 3).

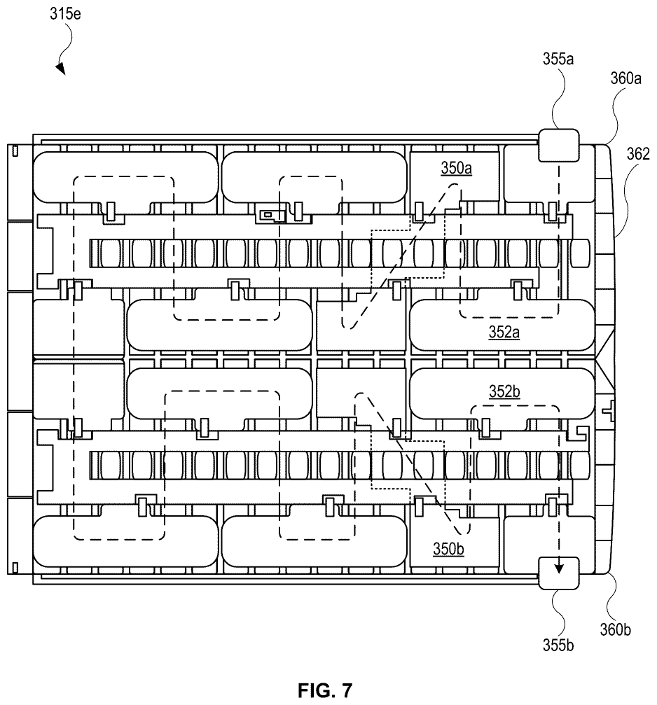

FIG. 7 illustrates an enlarged aerial view of an example of the battery module 315e, showing an exemplary electrical current flow path, in accordance with one or more implementations of the present disclosure. The electrical current flow path is represented by a dotted line. As shown, the electrical current may flow from the terminal 355a to the busbar 352a via one or more battery cells (shown, not labeled) and subsequently from the busbar 352a to the busbar 350a. The electrical current may continue to flow through the remaining busbars and/or battery cells, including through the busbars 350b and 352b, where the electrical current flows through the terminal 355b.

Using diagonal busbars (e.g., busbars 350a and 350b), the battery module 315e may not only provide increased energy output but also allow the terminals 354a and 354b to remain in their same respective positions (e.g., positions on a battery module with a different electrical configuration). As shown, the terminal 355a and the terminal 355b are located at or near a corner 360a and a corner 360b, respectively, of the battery module 315e, with the corners 360a and 360b defining respective ends of a lateral edge 362 of the battery module 315e. Accordingly, the terminals 354a and 354b may be positioned at or near the same lateral edge (e.g., lateral edge 362). By maintaining the terminals 354a and 354b in their same respective positions, the battery module 315e may require minimal design changes for different electrical configurations.

Aspects of the subject technology can help extend the life of a battery in a vehicle but increasing versatility of battery modules. This can help facilitate the functioning of and/or proliferation of batteries, which can positively impact the climate by reducing greenhouse gas emissions.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a current collector assembly comprising:
a first busbar comprising:
a first portion configured to electrically coupled to a first set of prismatic battery cells,
a second portion positioned laterally with respect to the first portion, the second portion configured to electrically coupled to a second set of prismatic battery cells; and
a third portion connected the first portion and the second portion.

2. The apparatus of claim 1, wherein the third portion is diagonal with respect to the first portion and the second portion.

3. The apparatus of claim 1, wherein the third portion comprises:
a first opening aligned with a first vent of a prismatic battery cell of the first set of prismatic battery cells; and
a second opening aligned with a second vent of a prismatic battery cell of the second set of prismatic battery cells.

4. The apparatus of claim 1, wherein the first busbar is configured to electrically couple the first set of prismatic battery cells to the second set of prismatic battery cells.

5. The apparatus of claim 4, wherein the first busbar is configured to electrically couple in parallel the first set of prismatic battery cells to the second set of prismatic battery cells.

6. The apparatus of claim 1, wherein the first busbar is configured to electrically couple in parallel at least three prismatic battery cells of the first set of prismatic battery cells or the second set of prismatic battery cells.

7. The apparatus of claim 1, wherein the first busbar is configured to electrically couple in parallel at least six prismatic battery cells, wherein the at least six prismatic battery cells are from the first set of prismatic battery cells and from the second set of prismatic battery cells.

8. The apparatus of claim 1, wherein the first busbar is configured to electrically couple in parallel at least three positive terminals of the first set of prismatic battery cells to at least three positive terminals of the second set of prismatic battery cells.

9. The apparatus of claim 1, wherein:
the current collector assembly further comprises a second busbar electrically coupled with the first set of prismatic battery cells,
the first busbar comprises a first shape, and
the second busbar comprises a second shape different from the first shape.

10. A battery subassembly, comprising:
a battery module comprising:
a first prismatic battery cell having a first type terminal;
a second prismatic battery cell separate from the first prismatic battery cell and having the first type terminal; and
a busbar comprising:
a first portion electrically coupled to the first type terminal of the first prismatic battery cell,
a second portion electrically coupled to the first type terminal of the second prismatic battery cell, and
a third portion connected to the first portion and the second portion.

11. The battery subassembly of claim 10, wherein the first type terminal comprises a positive terminal.

12. The battery subassembly of claim 10, wherein the first portion is parallel with respect to the second portion.

13. The battery subassembly of claim 12, wherein the third portion is structurally non-parallel with respect to the first portion and the second portion.

14. The battery subassembly of claim 10, further comprising:
a circuit board disposed over the busbar; and
a sensor electrically coupled to the circuit board and configured to monitor the first prismatic battery cell.

15. The battery subassembly of claim 10, wherein the first portion is configured to electrically couple with at least three prismatic battery cells.

16. The battery subassembly of claim 15, wherein the second portion is configured to electrically couple with at least three prismatic battery cells.

17. The battery subassembly of claim 16, wherein the busbar is configured to electrically couple in parallel six prismatic battery cells.

18. A vehicle, comprising:
a battery subassembly comprising:
a first busbar configured to electrically couple in parallel i) a first set of prismatic battery cells comprising at least three prismatic battery cells and ii) a second set of prismatic battery cells comprising at least three prismatic battery cells, the first busbar comprising a first shape, and
a second busbar configured to electrically couple in series i) the first set of prismatic battery cells and ii) a third set of prismatic battery cells, the second busbar comprising a second shape different from the first shape.

19. The vehicle of claim 18, wherein the first busbar comprises:
a first portion configured to electrically couple to the first set of prismatic battery cells,
a second portion configured to electrically couple to the second set of prismatic battery cells, and
a third portion connected to the first portion and the second portion.

20. The vehicle of claim 19, wherein:
the first portion is parallel with respect to the second portion, and
the third portion is structurally non-parallel with respect to the first portion and the second portion.
